(19) United States
(12) Patent Application Publication
(10) Pub. No.: US 2007/0169579 A1
(43) Pub. Date: Jul. 26, 2007

(54) Adjuster for powered movement of a safety belt in a motor vehicle, fastening device, and method for fastening the adjuster

(76) Inventors: Konrad Dankowski, Ganbsheim (FR); Daniel Ihle, Buehl-Altschweier (DE); Christine Strominski, Lichtenau (DE)

Correspondence Address: Striker Striker & Stenby, 103 East Neck Road, Huntington, NY, 11743, US

(21) Appl. No.: 10/587,532

(22) PCT Filed: Apr. 28, 2005
(86) PCT No.: PCT/EP05/51940

§ 371 Date: Jul. 26, 2006

(30) Foreign Application Priority Data
Jun. 11, 2004 (DE) 10 2004 028 280.3

(51) Int. Cl. F16H 1/04

(52) U.S. Cl. 74/422

(57) ABSTRACT

An adjusting device (10) for motorized movement of a safety belt (12) in a motor vehicle, as well as a fastening device (11) and a method for fastening the adjusting device, having a transmission (22) that is contained in a transmission housing (20) and is equipped with a drive pinion (52); the drive pinion (52) meshes with a toothed rack (26), which is able to slide in the longitudinal direction (64) through a guide element (28) of the adjusting device (10); and the transmission housing (20) has a through bore (82) through which a bolt (80) affixed to the vehicle body is able to pass in order to fasten the adjusting device (10) in place.

### PRIOR ART

The present invention relates to an adjusting device for motorized movement of a safety belt in a motor vehicle, as well as a fastening device and a method for fastening the adjusting device, as described in the preambles to the independent claims.

EP 0 542 773 B1 has disclosed a safety belt deploying system in which an electric motor drive unit uses a drive pinion to slide a toothed rack longitudinally in a guide sleeve. The guide sleeve extends essentially over the entire length of the toothed rack and is attached directly to the vehicle body. In such a design, the guide sleeve is as a rule embodied in the form of a stamped and bent metallic part on which an attachment flange is provided for attachment to the vehicle body. The electric drive unit is then also fastened to the attachment flange by fasteners in such a way that the drive pinion engages with the toothed rack. An adjusting device of this kind is relatively heavy and is expensive to produce. The installation of the safety belt deploying system using several attachment points is therefore dependent on the tolerances of the vehicle body.

### ADVANTAGES OF THE INVENTION

The adjusting device according to the present invention for motorized movement of a safety belt, a fastening device, and a method for fastening the adjusting device, with the defining characteristics of the independent claims, have the advantage that providing a through bore through the entire transmission housing permits the adjusting device to be fastened to the vehicle body by means of a single attachment point. This makes it unnecessary for the fastening flange, with its plurality of bores or elongated holes, to be adjusted in relation to the vehicle body. The sliding of the adjusting device onto the bolt affixed to the housing simplifies installation considerably. This eliminates the separate production and installation of the attachment flange since the through bore is produced in one work cycle with the production of the transmission and the transmission housing.

Advantageous modifications and improvements of the defining characteristics disclosed in the independent claims ensue from the steps taken in the dependent claims. If the drive pinion mounted in the transmission housing has a through bore through which the bolt affixed to the housing is guided when the adjusting device is being mounted in place, then the moments occurring during operation are optimally transmitted from the transmission to the vehicle body. If the adjusting device is rotated on the bolt, then only the angular position of the toothed rack changes, which can also be determined by another contact surface.

If the drive pinion is combined with a worm gear to form a single component, then this component, which has a through bore extending through it, can be produced and mounted in the transmission housing in a very favorable manner. This allows not only the forces exerted by the electric motor via the worm gear pair, but also the forces introduced via the toothed rack to be absorbed directly inside the component by the bolt affixed to the vehicle body.

Because of the embodiment of the through bore in the drive pinion and in the worm gear, these can no longer be supported in a fixed fashion by means of a shaft inside the transmission housing. It is therefore advantageous for a radial bearing surface to be formed onto the entire component comprised of the drive pinion and the worm gear, which bearing surface is accommodated by a cylindrical recess in the transmission housing. This leaves the hub region of the component available for the through bore.

To axially fix the drive pinion and the worm gear in the transmission housing, the housing is provided with axial stop surfaces so that when the transmission housing is mounted on the bolt, the drive pinion and the worm gear are also axially fixed in relation to the vehicle body.

In an advantageous embodiment, the transmission housing is composed of a base body and a transmission cover, whose dividing surface extends essentially transversely in relation to the axis of the drive pinion. Such an arrangement makes it possible, in a single assembly step, for the transmission housing to be tightly closed and the drive pinion and worm gear to be reliably supported. Making the transmission housing out of plastic significantly reduces the overall weight of the belt hand-over. Manufacturing the through bore by means of injection molding in the same work cycle as the production of the transmission housing eliminates the need for the relatively expensive sheet metal processing and assembly required with conventional attachment flanges.

The integral embodiment of the guide element with the transmission housing permits this component to enclose and support the drive pinion particularly well, thus permitting the support of the drive pinion and the toothed rack in relation to each other to be embodied as very stable and wear resistant and eliminating a complex adjustment of the drive pinion in relation to the toothed rack during assembly.

If the drive pinion and a worm gear together are embodied as one component, then the worm gear pair can be used to fasten the electric motor to the transmission housing, not only in a frictional, non-positive fashion, but also in a mechanical fashion without play. The fastening of the worm gear to the bolt affixed to the vehicle body therefore eliminates the need for a separate fastening of the relatively heavy electric motor.

The fastening device according to the present invention permits the belt hand-over to be marketed in the form of a very compact unit, with or without an inserted toothed rack. This makes it unnecessary to separately produce an attachment flange and guide rail for the toothed rack since the entire belt hand-over is fastened to the vehicle body directly via the through bore in the transmission housing.

The rotary support of the adjusting device on the bolt makes it possible to adapt the angular position of the toothed rack in a user-specific fashion when necessary.

In order to set a preferred angular position, the vehicle body advantageously has an additional pin attached to it, against which the toothed rack or electric drive unit rests. This sliding contact eliminates an assembly step that would be required for an additional attachment point.

To axially fix the adjusting device, the bolt has, for example, a thread onto which a nut is screwed after the transmission housing is slid into place. Alternatively, however, it is also possible to use other retaining elements such as clamp rings, cotter pins, or other form-locked or frictional, non-positive fasteners.

### DRAWINGS

The drawings show exemplary embodiments of adjusting devices according to the present invention for motorized movement of a safety belt and are explained in greater detail in the description that follows.

FIG. 1 shows a belt hand-over according to the present invention, installed in a vehicle body,

FIGS. 2 and 3 show two views of the adjusting device, without a toothed rack,

FIG. 4 shows another exemplary embodiment of a belt hand-over, with an attachment device,

FIG. 5 shows a section through the transmission housing of the embodiment from FIG. 4,

FIG. 6 schematically depicts another attachment device, and

FIG. 7 shows a belt hand-over according to the prior art.

### DESCRIPTION OF THE EXEMPLARY EMBODIMENTS

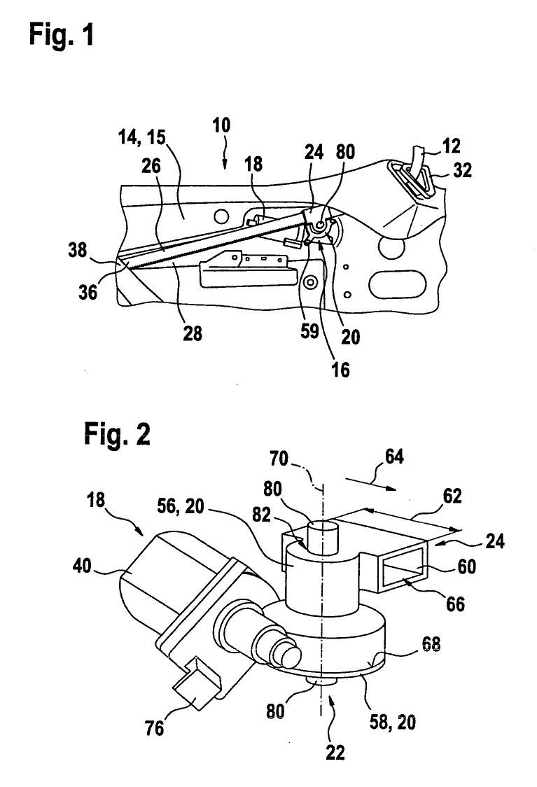

FIG. 1 shows an adjusting device 10 for motorized movement of a safety belt 12 that is installed in a side wall 14 of a vehicle body 15, for example in a coupe, which has doors only in the region of the front seats. The adjusting device 10 has an electric drive unit 16 with an electric motor 18 and a transmission 22 contained in a transmission housing 20. The electric drive unit 16 has a through bore 82 that serves as a receptacle for a bolt 80 affixed to the vehicle body, which serves to mount the adjusting device 10 snugly onto the side wall 14. The transmission housing 20 has an integral component in the form of a guide element 24 for a toothed rack 26, which, like the drive unit 16, is contained in a recess 28 in the side wall 14. At a front end 30, the toothed rack 26 is provided with a triangle 32 through which the safety belt 12 is guided. In the neutral position shown, the toothed rack 26 lies with a rear end 36 against a stop 38 of the vehicle body 15. If, for example, the ignition key of the motor vehicle is actuated, then the adjusting device 10 automatically moves the belt 12 from the rear toward the driver in the driver's seat, making it easier for the driver to reach the belt 12.

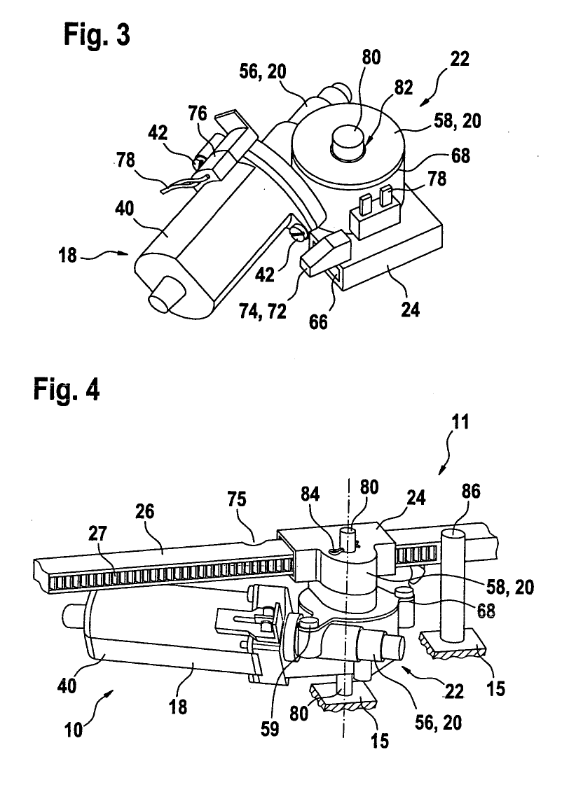

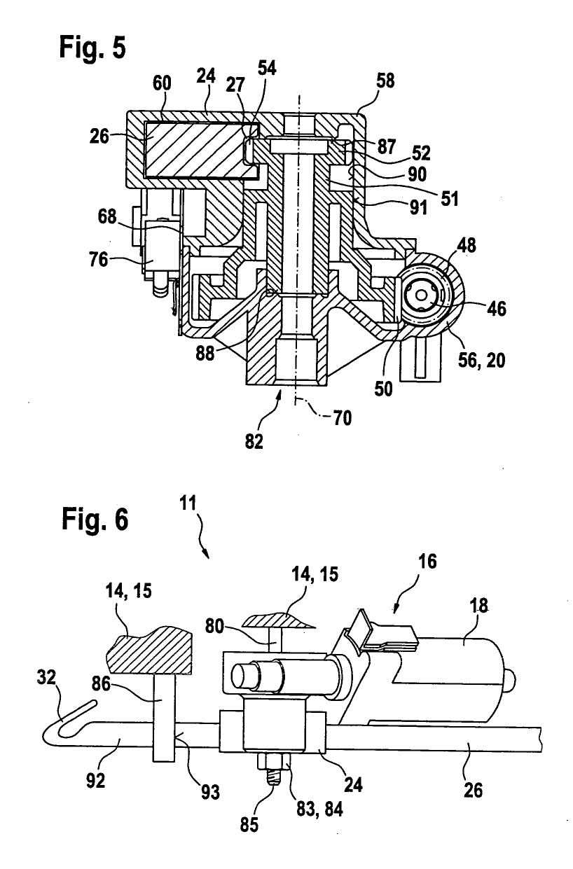

FIGS. 2 and 3 show enlarged views of the electric drive unit 16; the electric motor 18 has a pole cup 40, which is fastened to the transmission housing 20 by means of fasteners 42, for example screws 42. A worm 48 supported on an armature shaft 46 operationally connects the electric motor 18 to a worm gear 50, as shown in detail in FIG. 5. The worm gear 50 is in turn rigidly connected to a drive pinion 52 whose teeth 54 engage in the toothed rack 26, which is not shown in detail. In the exemplary embodiment, the transmission housing 20 has a base body 56 that encloses the armature shaft 46, the worm gear 50, and the drive pinion 52. In the region of the drive pinion 52, the transmission housing is integrally joined to the guide element 24, which can accommodate the toothed rack 26. The guide element 24 has an essentially rectangular cross section 60 and extends for a length 62 that approximately corresponds to the dimension of the transmission housing 20 along the longitudinal direction 64 of the toothed rack 26. The guide element 24 has openings 66 at both ends that permit the toothed rack 26 to be slid through it. The transmission housing 20 also has a transmission cover 58 in order to close the worm gear 50; the dividing plane 68 between the transmission cover 58 and the base body 56 extends approximately perpendicular to an axis 70 of the drive pinion 52 and the worm gear 50. The transmission housing 20, the drive pinion 52, and the worm gear 50 here have the through bore 82 along the axis 70, into which the bolt 80 affixed to the vehicle body is inserted. The drive pinion 52 here is supported completely inside the transmission housing 20. The transmission housing 20 is preferably produced of plastic, by means of the injection molding process.

In FIG. 3, a microswitch 74 is provided as a position determining device 72 on the guide element 24 and engages with corresponding switching indentations 75 on the toothed rack 26. The microswitch 74 and a plug contact 76 are connected to the electric motor 18 by means of electrical connections 78 that are not shown in detail.

FIG. 4 shows another exemplary embodiment of a fastening device 11 of a belt hand-over 10 that has a toothed rack 26 contained in the guide element 24. The toothed rack 26 protrudes from both openings 66; the front end 30 of the toothed rack 26 is provided with the triangle 32 for the belt 12 and the rear end 36 can be moved against a stop 38. The drive pinion 52, which cannot be seen in detail, engages by means of its gearing 54 in the teeth 27 of the toothed rack 26; the distance between the drive pinion 52 and the toothed rack 26 is predetermined by the guide element 24 that is integral to the transmission housing 20. In this exemplary embodiment, the dividing plane 68 between the cover 58 and the base body 56 of the transmission housing 20 lies between the worm gear 50 and the drive pinion 52. The two housing parts 56, 58 are fastened to each other by fasteners 59 so that when assembly of the transmission housing 20 is complete, the toothed rack 26 is also connected to the electric motor 18 in a frictional, non-positive fashion. As a fastening device 11, the adjusting device 10 is attached to the side wall 14 by means of the bolt 80 that is affixed to the vehicle body and passes through the through bore 82 of the transmission housing 20. In order to axially fix the adjusting device 10, it is attached to the bolt 80 by means of a retaining element 84. Since the transmission housing 20 is supported so that it can rotate in relation to the fixed bolt 80, another pin 86 affixed to the vehicle body is provided, which fixes the angular position of the adjusting device 10.

FIG. 5 shows an enlarged section through the transmission housing in FIG. 4 along the line V-V. The drive element 52 here is embodied as integrally joined to the worm gear 50, both of them having the central through bore 82 24. The drive pinion 52 and the worm gear 50 comprise a shared component 51 that is supported completely within the transmission housing 20. To this end, the transmission housing 20 has axial stop surfaces 87, 88 against which the drive pinion 52 and the worm gear 50 rest for axial support. The radial support of the component 51 is achieved by means of a circumference surface 90 that is guided in a correspondingly cylindrical recess 91 in the transmission housing 20. The gearing 54 of the drive pinion 52 here has a definite distance from the teeth 27 of the toothed rack 26. In order to attach the transmission housing 20, the through bore 82 that passes through the transmission housing 20 and the component 51 is slid onto the bolt 80 affixed to the vehicle body.

FIG. 6 shows another schematic depiction of the fastening device 11 of the adjusting device 10 for moving the belt 12. The bolt 80 and the pin 86 are attached, for example welded, in non-rotating fashion in the recess 28 in the vehicle body. In order to assemble the belt hand-over 10, the drive unit 16 with the inserted toothed rack 26 is slid onto the bolt 80. The freely extending end of this bolt has a thread 85 onto which a threaded nut 83 is then placed in order to axially fix the adjusting device 10. The pin 86 is situated between the bolt 80 and the triangle 32 so that the toothed rack 26 rests with a contact surface 92 against a counterpart contact surface 93 of the pin 86 affixed to the vehicle body. In the neutral state, the toothed rack, with the inserted safety belt 12, is thus held in a fixed angular position. Alternatively, the belt hand-over 10 can also rest against a contact surface 92 of the transmission housing 20 or the guide element 24.

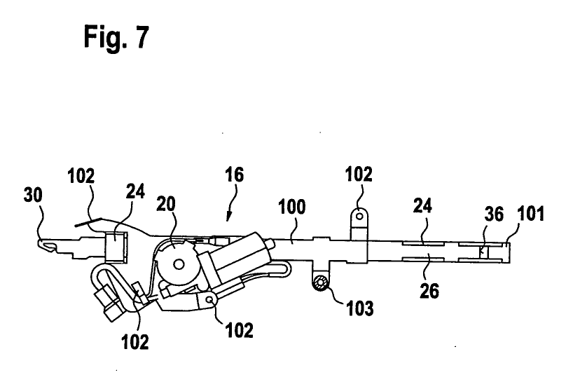

FIG. 7 shows a conventional belt hand-over 10 as an example of the prior art. In this instance, the drive unit 16 is screw-connected to an attachment flange 100, which in turn is fastened to the guide element 24 of the toothed rack 26. The guide element 24 here extends essentially over the entire length of the toothed rack 26. One end of the guide element 24 is provided with a stop buffer 101 in order to produce an elastic damping when the rear end 36 of the toothed rack 26 strikes against the stop 38. The attachment flange 100 has several openings 102 for fastening elements 103, which are used for fastening the belt hand-over 10 and for adjusting it in relation to the vehicle body 15. For assembly in this case, first, the attachment flange 100 is formed onto the guide element 24—for example by means of material shaping—and then the transmission housing 20 is fastened to the attachment flange 100 so that the drive pinion 52, which protrudes from the transmission housing 20 in this instance, engages with the teeth 27 of the toothed rack 26.

It should be noted with regard to the exemplary embodiments shown in the figures and mentioned in the drawings that there are numerous possibilities for combining the individual defining characteristics with one another. It is thus possible, for example, to vary the concrete embodiment of the transmission housing 20, the guide element 24, the transmission 22, the motor 18, and the fastening bolts and pins 80, 86; what is essential to the present invention is that the through bore 82 extends through the transmission housing 20. It is thus possible for the guide element 24 to be embodied, for example, as a separate component and for the drive pinion to be located axially outside the transmission housing 20. The present invention also includes an adjusting device 10 without the mounting of the toothed rack 26 and can basically also be used for similar linear adjustment applications, particularly in motor vehicles.

What is claimed is:

1. An adjusting device (10) for motorized movement of a safety belt (12) in a motor vehicle, having a transmission (22) that is contained in a transmission housing (20) and is equipped with a drive pinion a drive pinion (52); the drive pinion (52) meshes with a toothed rack (26), which is able to slide in the longitudinal direction (64) through a guide element (28) of the adjusting device (10),
wherein the transmission housing (20) has a through bore (82) through which a bolt (80) affixed to the vehicle body is able to pass in order to fasten the adjusting device (10) in place.

2. The adjusting device (10) as recited in claim 1,
wherein the through bore (82) passes axially through the drive pinion (52).

3. The adjusting device (10) as recited in claim 1,
wherein the drive pinion (52) is embodied as integrally joined to an axially offset worm gear (50) through which the through bore (82) likewise passes axially.

4. The adjusting device (10) as recited in claim 1,
wherein the drive pinion (52) and the worm gear (50) are supported radially in the transmission housing (20) by means of at least one outer circumference surface (90).

5. The adjusting device (10) as recited in claim 1,
wherein the transmission housing (20) has at least two axial stop surfaces (87, 88) that support the drive pinion (52) and the worm gear (50) axially.

6. The adjusting device (10) as recited in claim 1,
wherein the transmission housing (20) has a base body (56) and a transmission cover (58) that are attachable to each other and are manufactured out of plastic-in particular by means of the injection molding process.

7. The adjusting device (10) as recited in claim 1,
wherein the guide element (28) is an integral component of the transmission housing (20).

8. The adjusting device (10) as recited in claim 1,
wherein the worm gear (50) is operationally connected via a worm shaft (48, 46) to an electric motor (18) that is connected to the transmission housing (20).

9. A fastening device () for a belt hand-over,
wherein a bolt (80) affixed to the vehicle body passes through a through bore (82) that is provided in a transmission housing (20) of an adjusting device (10)—in particular as recited in claim 1.

10. The fastening device (11) as recited in claim 9,
wherein the transmission housing (20) is supported in rotary fashion on the bolt (80) affixed to the vehicle body.

11. The fastening device (11) as recited in claim 9,
wherein after the adjusting device (10) is mounted on the bolt (80) affixed to the vehicle body, the adjusting device (10) is axially fixed by means of a retaining element (84)—in particular by means of a threaded nut (84) that is placed onto a thread of the bolt (80) affixed to the vehicle body.

12. The fastening device (11) as recited in claim 9,
wherein in order to align the angular position of the adjusting device (10), the adjusting device has a contact surface (92) that cooperates with a corresponding counterpart contact surface (93) that is fixed in relation to the vehicle body and in particular, is situated on another pin (86) affixed to the vehicle body.

13. A method for attaching an adjusting device (10) for motorized movement of a safety belt (12) in a motor vehicle, in particular as recited in claim 1, in which the adjusting device (10) has a transmission (22) with a transmission housing (20),
wherein first, a bolt (80) is attached to a vehicle body () of the motor vehicle, then the adjusting device (10), which is equipped with a through bore (82) that passes through the transmission (22) and the transmission housing (20), is slid onto the bolt (80), and then the adjusting device (10) is axially fixed to the bolt with a retaining element (84).
